(19) United States
(12) Patent Application Publication
(10) Pub. No.: US 2025/0391172 A1
(43) Pub. Date: Dec. 25, 2025

(54) ASSISTANCE SYSTEM FOR ARRANGEMENT WORK ON DEVICES OF ELEVATOR

(71) Applicant: Mitsubishi Electric Corporation, Tokyo (JP)

(72) Inventor: Yoshinao TAKAHASHI, Tokyo (JP)

(73) Assignee: Mitsubishi Electric Corporation, Tokyo (JP)

(21) Appl. No.: 18/878,675

(22) PCT Filed: Jul. 5, 2022
(86) PCT No.: PCT/JP2022/026707

§ 371 Date: Dec. 24, 2024

(51) Int. Cl. G06V 20/52; G06F 3/16; G06T 11/00; G06V 20/20

(52) U.S. Cl. CPC G06V 20/52; G06F 3/16; G06T 11/00; G06V 20/20

(57) ABSTRACT

To provide an assistance system that can be applied to arrangement work on a wide variety of devices of an elevator. An assistance system includes an image capturing apparatus and a guidance system. The image capturing apparatus captures, in arrangement work, an image of an area including a position of a target arrangement corresponding to each of one or more devices of an elevator. The arrangement work is work involving arranging each of the devices in a corresponding target arrangement. The guidance system guides arrangement of each of the devices in the corresponding target arrangement based on the image captured by the image capturing apparatus.

### TECHNICAL FIELD

The present disclosure relates to an assistance system for arrangement work on devices of an elevator.

### BACKGROUND ART

PTL 1 discloses an example of a method of arranging a buffer footing of an elevator. In the method, positioning of a visible laser apparatus is performed based on a reference wire material lowered vertically downward in a hoistway. Positioning of the buffer footing is performed in a pit by aligning a laser beam emitted from the visible laser apparatus with an indicator of the buffer footing.

### CITATION LIST

### Patent Literature

[PTL 1] JP 2010-70268 A

### SUMMARY OF THE INVENTION

### Problems to be Solved by the Invention

A wide variety of devices including a buffer footing are arranged in an elevator. However, since the method according to PTL 1 is based on a reference wire material lowered vertically downward in a hoistway, the method cannot be applied to arrangement of devices not provided in a pit.

The present disclosure is related to a solution of such a problem. The present disclosure provides an assistance system that can be applied to arrangement work on a wide variety of devices of an elevator.

### Means to Solve the Problem

An assistance system according to the present disclosure includes an image capturing apparatus that, in arrangement work of arranging each of one or more devices of an elevator in a corresponding target arrangement, captures an image of an area including a position of a target arrangement corresponding to each of the one or more devices; and a guidance system that provides guidance for arrangement in the corresponding target arrangement of each of the one or more devices based on the image captured by the image capturing apparatus.

### Advantageous Effects of the Invention

The assistance system according to the present disclosure can be applied to arrangement work on a wide variety of devices of an elevator.

### BRIEF DESCRIPTION OF DRAWINGS

FIG. 1 is a perspective view of an example of devices of an elevator to which an assistance system according to a first embodiment is applied.

FIG. 2 is a top view of the traction machine according to the first embodiment.

FIG. 3 is a configuration diagram of the assistance system according to the first embodiment.

FIG. 4 is a diagram showing an example of display by the display unit according to the first embodiment.

FIG. 5 is a diagram showing an example of display by the display unit according to the first embodiment.

FIG. 6 is a flowchart showing an example of operations of the assistance system according to the first embodiment.

FIG. 7 is a top view of another example of a device of an elevator to which the assistance system according to a first embodiment is applied.

FIG. 8 is a top view of another example of a device of an elevator to which the assistance system according to a first embodiment is applied.

FIG. 9 is a diagram showing another example of display by the display unit according to the first embodiment.

FIG. 10 is a diagram showing an example of extraction of a feature portion by the target arrangement obtaining unit according to the first embodiment.

FIG. 11 is a diagram showing an example of extraction of a feature portion by the target arrangement obtaining unit according to the first embodiment.

FIG. 12 is a diagram showing an example of extraction of a feature portion by the target arrangement obtaining unit according to the first embodiment.

FIG. 13 is a diagram showing an example of extraction of a feature portion by the target arrangement obtaining unit according to the first embodiment.

FIG. 14 is a diagram showing an example of extraction of a feature portion by the target arrangement obtaining unit according to the first embodiment.

FIG. 15 is a diagram showing an example of extraction of a feature portion by the target arrangement obtaining unit according to the first embodiment.

FIG. 16 is a diagram showing an example of extraction of a feature portion by the target arrangement obtaining unit according to the first embodiment.

FIG. 17 is a diagram showing an example of obtaining a target arrangement by the target arrangement obtaining unit according to the first embodiment.

FIG. 18 is a configuration diagram of the assistance system according to a modification of the first embodiment.

FIG. 19 is a diagram showing an example of obtaining a target arrangement by the target arrangement obtaining unit according to a modification of the first embodiment.

FIG. 20 is a hardware configuration diagram of substantial parts of the assistance system according to the first embodiment.

FIG. 21 is a configuration diagram of the guidance system according to a second embodiment.

FIG. 22 is a diagram showing an example of a trained model in the learning unit according to the second embodiment.

FIG. 23 is a diagram showing an example of a trained model in the learning unit according to the second embodiment.

FIG. 24 is a flowchart showing an example of operations of the assistance system according to the second embodiment.

FIG. 25 is a flowchart showing an example of operations of the assistance system according to the second embodiment.

FIG. 26 is a diagram showing an example of display by the display unit according to a modification of the second embodiment.

### DESCRIPTION OF EMBODIMENTS

A mode for carrying out the present disclosure will be described while referring to the accompanying drawings. Same or corresponding portions in each drawing will be denoted by same reference signs and overlapping descriptions thereof will be simplified or omitted as deemed appropriate.

### First Embodiment

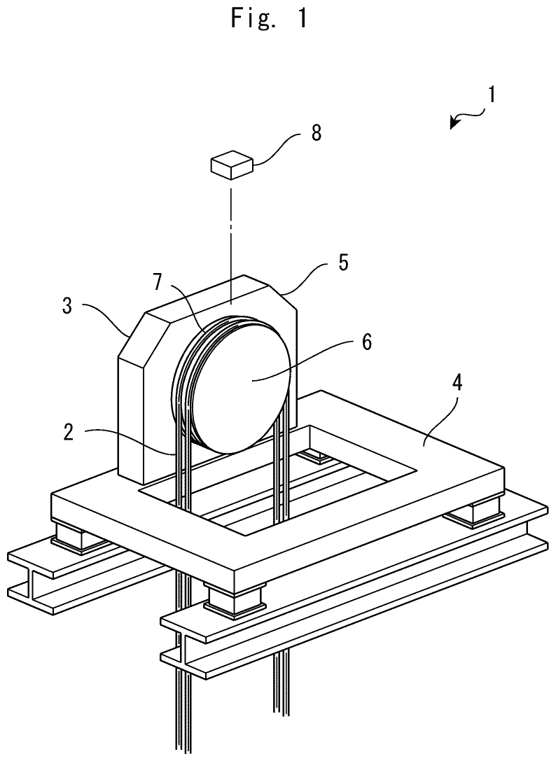

FIG. 1 is a perspective view of an example of devices of an elevator to which an assistance system 1 according to a first embodiment is applied.

The assistance system 1 is applied to arrangement work on devices of an elevator. For example, the devices of an elevator include apparatuses that operate in the elevator, members that constitute the elevator, and components of such apparatuses and members. Arrangement work is work involving arranging the devices of the elevator in target arrangements that correspond to the devices. In arrangement work, one or more devices are arranged in respectively corresponding target arrangements. The target arrangement of each device is, for example, an arrangement of the device during a normal operation of the elevator or the like. In this case, the arrangement of a device includes a position and an attitude of the device. In arrangement work, an order of arrangement may be set in advance with respect to at least any of the devices to be arranged. For example, arrangement work includes work for installing a new elevator, work for updating an elevator, and work for replacement or maintenance checkup of a device of an elevator. The work for maintenance checkup of a device of an elevator may include a step of removing the device of an elevator and putting the device back into place after adjusting or cleaning the device.

For example, an elevator is applied to a building with a plurality of floors. The building is provided with a hoistway of the elevator (not illustrated). The hoistway is a vertically-long space which extends across a plurality of floors in the building. An elevator hall (not illustrated) is provided on each floor. A hall door is provided in the hall of each floor. The hall door is a door that partitions the hall and the hoistway from each other.

The elevator includes a car (not illustrated), a hoisting rope 2, and a traction machine 3. The car is an apparatus that transports users or the like among a plurality of floors by traveling in a vertical direction in the hoistway. The hoisting rope 2 is a rope that suspends the car in the hoistway. The elevator may be provided with a plurality of hoisting ropes 2. The traction machine 3 is an example of a device of the elevator. FIG. 1 represents a perspective view of the traction machine 3. The traction machine 3 is provided in, for example, a machine room. For example, the machine room is provided above the hoistway of the elevator. A traction machine table 4 is provided in the machine room. The traction machine table 4 is a table that acts as a base of the traction machine 3. The traction machine 3 is equipped with a motor 5 and a sheave 6. The motor 5 and the sheave 6 are each an example of a device of the elevator. In arrangement work, the traction machine 3 may be arranged by being divided into the motor 5 and the sheave 6. The motor 5 is an apparatus that rotates and drives the sheave 6. The sheave 6 includes a sheave groove 7. The sheave groove 7 is a groove around which the hoisting rope 2 is wound in the sheave 6. For example, the hoisting rope 2 is lowered from the sheave 6 to the hoistway through a rope duct provided in the machine room. In the elevator, the car travels in the vertical direction in the hoistway as the hoisting rope 2 is hoisted by the sheave 6 rotated and driven by the motor 5.

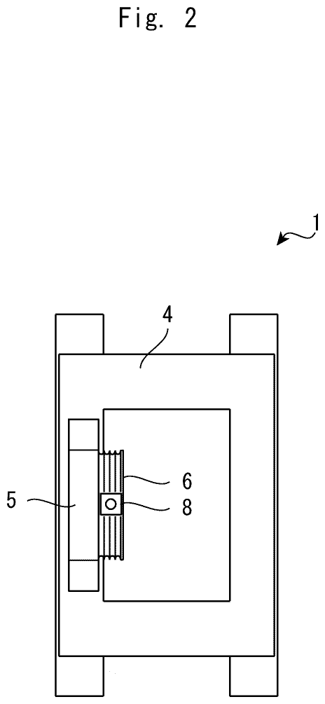

FIG. 2 is a top view of the traction machine 3 according to the first embodiment.

In this example, the assistance system 1 assists arrangement work of arranging the devices of the elevator including the traction machine 3. The assistance system 1 includes an image capturing apparatus 8.

The image capturing apparatus 8 is an apparatus such as a camera that captures an image. The image captured by the image capturing apparatus 8 may be either a still image or a moving image. The image capturing apparatus 8 captures an image of an area including a position of a target arrangement of the traction machine 3. The image capturing apparatus 8 is arranged vertically above the sheave 6 of the traction machine 3. The image capturing apparatus 8 is arranged directly above the sheave 6. In this example, the image capturing apparatus 8 is arranged on a vertical line that passes through a rotational axis of the sheave 6. The image capturing apparatus 8 may be arranged obliquely above an area including a position of a target arrangement of a device such as the traction machine 3.

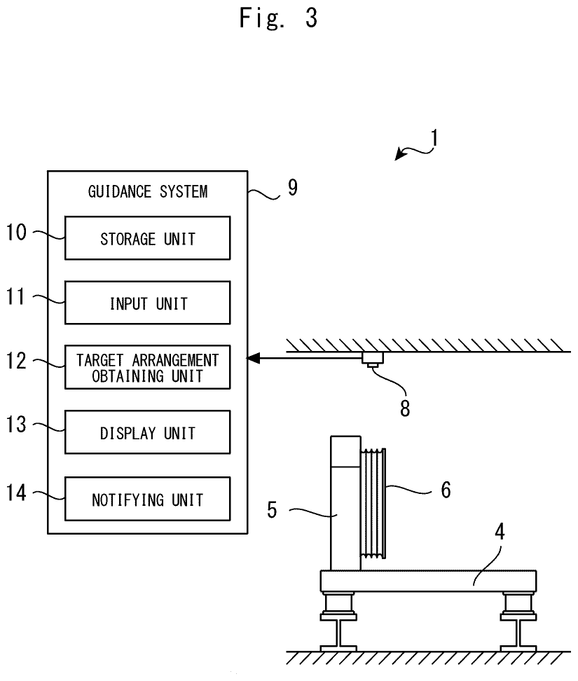

FIG. 3 is a configuration diagram of the assistance system 1 according to the first embodiment.

The image capturing apparatus 8 is fixed to a ceiling of the machine room above the sheave 6. The image capturing apparatus 8 is fixed so as to be prevented from moving from start to finish of the arrangement work. For example, the image capturing apparatus 8 is fixed by an anchor bolt, a magnet, a suction cup, an adhesive tape, or the like. For example, the image capturing apparatus 8 may be mounted to a stand to be installed in the machine room or the like. For example, the image capturing apparatus 8 may be mounted to a wall surface of the machine room. For example, the image capturing apparatus 8 may be fixed by a magnet chuck or the like. The image capturing apparatus 8 may be continuously fixed even after the arrangement work is completed. Alternatively, the image capturing apparatus 8 may be removed after the arrangement work is completed.

The assistance system 1 includes a guidance system 9. The guidance system 9 is a system constituted of a server apparatus that is, for example, installed in the building in which the elevator is provided or installed in another building. Alternatively, the guidance system 9 may be a system constituted of, for example, a portable information terminal such as a smartphone that is carried by a worker who performs arrangement work. Alternatively, the guidance system 9 may be a system constituted of a device built into the image capturing apparatus 8. The guidance system 9 may be a system constituted of a single device. The guidance system 9 may be a system constituted of a plurality of devices. In this case, the plurality of devices of the guidance system 9 may be connected to each other via a communication network such as the Internet. A part of or all of the functions of the guidance system 9 may be mounted to, for example, a virtual machine on a cloud service or the like. A part of or all of the functions of the guidance system 9 may be mounted to an edge server or the like that is connected to an external service through a communication network such as the Internet in the building in which the elevator is provided. The guidance system 9 includes a storage unit 10, an input unit 11, a target arrangement obtaining unit 12, a display unit 13, and a notifying unit 14.

The storage unit 10 is a portion that stores information. For example, the storage unit 10 stores information such as an order of arrangement of one or more devices of the elevator in arrangement work. For example, the input unit 11 is a portion that accepts input by a worker who performs arrangement work. For example, the input unit 11 is a touch panel, a mouse, a keyboard, or the like. The target arrangement obtaining unit 12 is a portion that obtains a target arrangement corresponding to each device to be arranged in the arrangement work. The display unit 13 is a portion that displays a guidance image that indicates a target arrangement corresponding to each device by superimposing the guidance image on an image captured by the image capturing apparatus 8. For example, the display unit 13 is a display. The notifying unit 14 is a portion that notifies a worker of an arrangement relationship with the target arrangement of each device. For example, the notifying unit 14 is a speaker that performs notification by audio or the like.

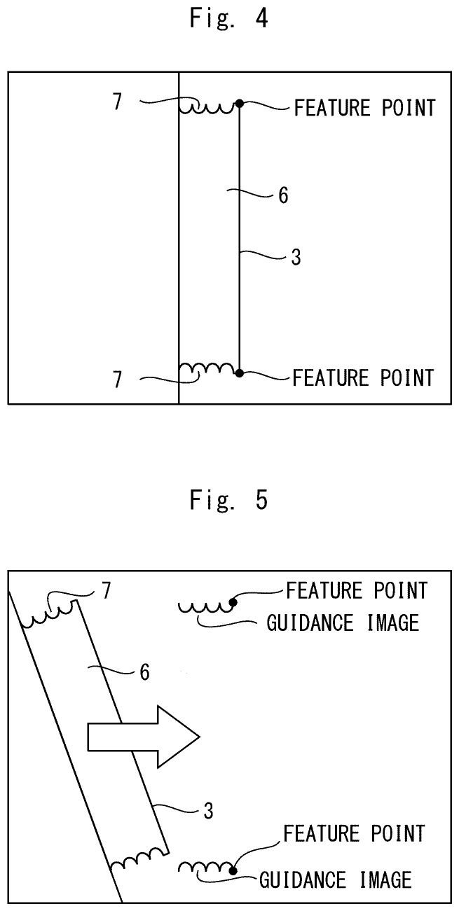

Next, functions of the assistance system 1 will be described with reference to FIGS. 4 and 5.

FIGS. 4 and 5 are diagrams showing an example of display by the display unit 13 according to the first embodiment.

In this example, arrangement work includes a step of replacing the existing traction machine 3 with a new traction machine 3.

FIG. 4 shows an image of a state where the existing traction machine 3 is being arranged.

The display unit 13 displays an image of the existing traction machine 3 captured by the image capturing apparatus 8.

The target arrangement obtaining unit 12 obtains a target arrangement of the traction machine 3 that is a device of the elevator. The target arrangement obtaining unit 12 obtains a target arrangement corresponding to the traction machine 3 based on, for example, an input from a worker. In this example, the target arrangement corresponding to the traction machine 3 is a position of the sheave groove 7 during a normal operation of the elevator. Information on a target arrangement includes information on a feature portion. The feature portion is one or a plurality of points or lines that indicate features of a position or an attitude of a device arranged in the target arrangement. In this example, the feature portion is a point indicating a position of the sheave groove 7. For example, the feature portion is a point indicating a position of an end of the sheave groove 7. For example, the target arrangement obtained by the target arrangement obtaining unit 12 is stored in the storage unit 10. The feature portion is used as, for example, a reference for guidance in arrangement work. The feature portion of a device is extracted using, for example, an image processing method from an image captured by the image capturing apparatus 8.

In the step of replacing the traction machine 3, the worker removes the hoisting rope 2 from the sheave 6 of the existing traction machine 3.

Subsequently, the worker inputs a target arrangement by, for example, tracing the sheave groove 7 of the existing traction machine 3 prior to being removed through the input unit 11 on an image captured by the image capturing apparatus 8. The target arrangement obtaining unit 12 obtains the target arrangement inputted through the input unit 11.

Subsequently, the worker removes the existing traction machine 3. Next, the worker temporarily places the new traction machine 3 in the machine room.

FIG. 5 shows an image of a state where the new traction machine 3 has been temporarily placed.

The display unit 13 displays an image of the new traction machine 3 captured by the image capturing apparatus 8.

The display unit 13 displays a guidance image by superimposing the guidance image on an image captured by the image capturing apparatus 8. The guidance image is an image that indicates the target arrangement obtained by the target arrangement obtaining unit 12. FIG. 5 shows an example of a guidance image corresponding to the traction machine 3. The guidance image is an image showing, for example, a position or an attitude of a feature portion of a device arranged in a target arrangement. In this example, an image showing a position and an attitude of the sheave 6 of the traction machine 3 arranged in the target arrangement is shown as the guidance image. In addition, a point indicating a position of an end of the sheave 6 of the traction machine 3 arranged in the target arrangement is shown as the guidance image. The guidance image may be vector image data of a point, a line, or the like indicating a position and an attitude of a device to be arranged. The point or the line indicating a position and an attitude of the device is, for example, a corner, an edge, or the like of a contour of the device. Alternatively, the guidance image may be raster image data such as a video of a device in a state where the device has been arranged in the target arrangement.

Based on the image displayed on the display unit 13, the worker adjusts a position of the new traction machine 3 having been temporarily placed. In this example, the worker moves the traction machine 3 toward the right of the drawing.

In this example, the guidance system 9 obtains the position of the new traction machine 3 by, for example, image recognition of an image captured by the image capturing apparatus 8. In this case, the display unit 13 may display an image of an arrow indicating a direction in which the new traction machine 3 is to be moved or the like as a part of the guidance image.

In addition, for example, in the notifying unit 14, a first range and a second range are set in advance with respect to an arrangement relationship such as a distance between the new traction machine 3 and a target arrangement corresponding to the traction machine 3. The first range is a range that represents that, for example, when a position and an attitude of the new traction machine 3 are within the first range, the new traction machine 3 has approached the target arrangement. The second range is a range that represents that, for example, when the position and the attitude of the new traction machine 3 are within the second range, the new traction machine 3 has been arranged in the target arrangement within an acceptable error range. The second range is included in the first range. The notifying unit 14 determines whether or not the position and the attitude of the new traction machine 3 obtained by, for example, image recognition have entered the first range and the second range. When the position and the attitude of the new traction machine 3 enter the first range, the notifying unit 14 notifies the worker that the new traction machine 3 has approached the target arrangement by emitting first audio. The first audio is, for example, audio set in advance such as an alarm sound or an audio guidance. When the position and the attitude of the new traction machine 3 enter the second range, the notifying unit 14 notifies the worker that the new traction machine 3 has been arranged in the target arrangement by emitting second audio. The second audio is, for example, audio set in advance such as an alarm sound or an audio guidance which differs from the first audio. The worker arranges the new traction machine 3 in the target arrangement while being guided by the display by the display unit 13 and the notification by the notifying unit 14.

Subsequently, the worker winds the hoisting rope 2 around the sheave 6 of the new traction machine 3. When there is a device to be arranged next, the worker carries out work for arranging the device. In doing so, the assistance system 1 guides arrangement of the device in a similar manner to the guidance of arrangement of the traction machine 3. On the other hand, when there is no device to be arranged next, the worker ends the arrangement work.

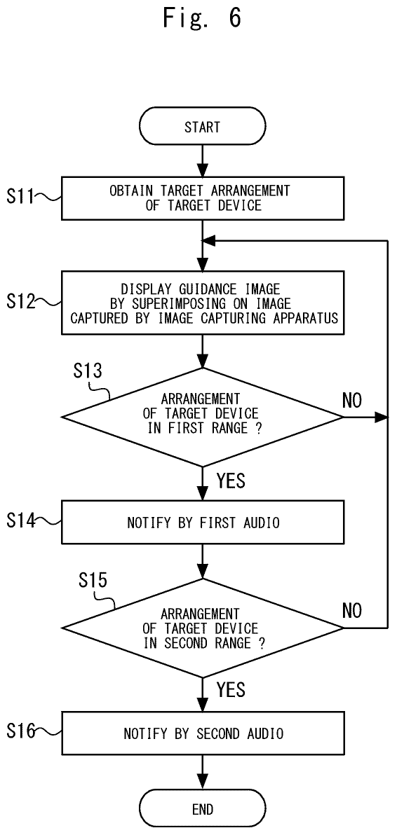

Next, an example of operations of the assistance system 1 will be described with reference to FIG. 6.

FIG. 6 is a flowchart showing an example of operations of the assistance system 1 according to the first embodiment.

FIG. 6 shows an example of operations of the assistance system 1 for guiding arrangement of any of the devices of the elevator.

In step S11, the target arrangement obtaining unit 12 obtains a target arrangement of a target device to be arranged. Subsequently, the operation of the assistance system 1 advances to step S12.

In step S12, the display unit 13 displays a guidance image that indicates a target arrangement corresponding to the target device by superimposing the guidance image on an image of the device having been captured by the image capturing apparatus 8. Subsequently, the operation of the assistance system 1 advances to step S13.

In step S13, the notifying unit 14 determines whether or not a position and an attitude of the target device are within the first range. When a determination result is Yes, the operation of the assistance system 1 advances to step S14. On the other hand, when the determination result is No, the operation of the assistance system 1 advances to step S12.

In step S14, the notifying unit 14 emits first audio. Subsequently, the operation of the assistance system 1 advances to step S15.

In step S15, the notifying unit 14 determines whether or not the position and the attitude of the target device are within the second range. When a determination result is Yes, the operation of the assistance system 1 advances to step S16. On the other hand, when the determination result is No, the operation of the assistance system 1 advances to step S12.

In step S16, the notifying unit 14 emits second audio. Subsequently, the operation of the assistance system 1 for guiding the arrangement of the target device ends. At this point, when there is another device to be arranged next in the arrangement work or the like, the assistance system 1 starts guidance for arrangement of the other device.

The image capturing apparatus 8 may include a plurality of cameras. Each camera is arranged at a position suitable for guidance of the arrangement of any of the devices. The position suitable for guidance of the arrangement of a device is a position where, for example, the image of the device is captured from a direction suitable for guidance of the arrangement of the device. The direction suitable for guidance of the arrangement of the device is, for example, a direction in which an admissible error in the arrangement of the device is largest or a direction perpendicular to a direction in which an admissible error in the arrangement of the device is smallest. Alternatively, each of the cameras may be arranged so that the arrangement of each device can be viewed stereoscopically. When the devices to be arranged include the traction machine 3, one of the cameras is arranged, for example, vertically above the sheave 6 of the traction machine 3. The camera is arranged directly above the sheave 6. In addition, one of the other cameras is arranged vertically below the sheave 6 of the traction machine 3. The camera is arranged directly below the sheave 6. The image capturing apparatus 8 may include a camera that is only either arranged vertically above or arranged vertically below the sheave 6 of the traction machine 3.

The devices to be arranged in arrangement work may be other devices of the traction machine 3. For example, a device to be arranged in arrangement work may be a car door apparatus. The car door apparatus is an apparatus which is provided in the car and which opens and closes so as to allow a user of the elevator to board and alight from the car. In this case, the image capturing apparatus 8 may include a camera to be arranged on a rear wall of a cab of the car. The cab is a portion boarded by a user in the car. The rear wall of the cab is, for example, a wall surface inside the cab which faces a space boarded by a user. The rear wall of the cab opposes the car door apparatus provided on a front surface of the car.

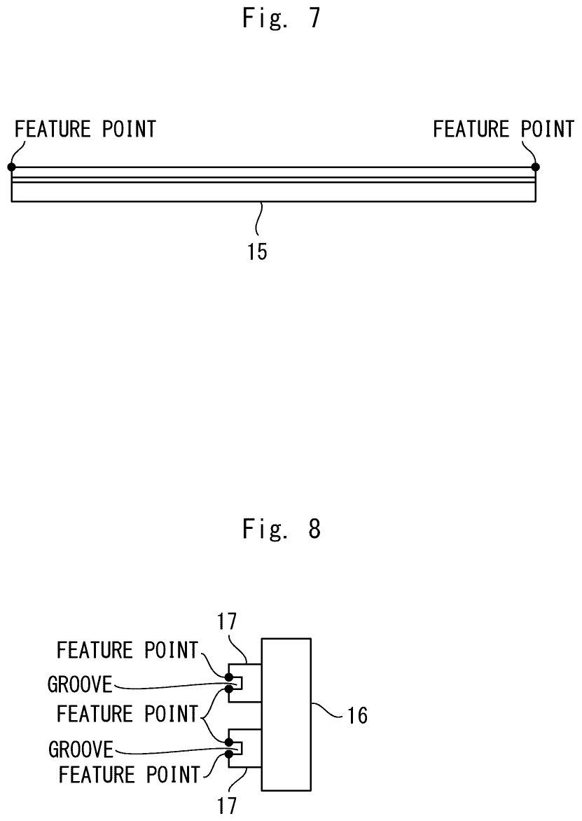

FIG. 7 is a top view of another example of a device of an elevator to which the assistance system 1 according to a first embodiment is applied.

FIG. 7 shows a top view of a landing sill 15 that is another example of a device of the elevator.

The landing sill 15 is a sill that guides opening and closing of the hall door. A feature portion of the target arrangement that corresponds to the landing sill 15 is, for example, points that indicate positions of both ends of the landing sill 15 during a normal operation of the elevator. In this case, the image capturing apparatus 8 includes a camera that captures an image of the landing sill 15 from vertically above.

FIG. 8 is a top view of another example of a device of an elevator to which the assistance system 1 according to a first embodiment is applied.

FIG. 8 shows a top view of a landing device 16 that is another example of a device of the elevator.

The landing device 16 is an apparatus that detects landing of the car at each floor. For example, the landing device 16 is provided in the car. For example, the landing device 16 detects a landing plate provided on each floor with a detection unit 17. The detection unit 17 has a groove which the landing plate passes when the car travels. For example, a feature portion of a target arrangement corresponding to the landing device 16 is a point indicating a position of an end of the groove. In this case, the image capturing apparatus 8 includes a camera that captures an image of the landing device 16 from vertically above or vertically below. For example, the camera is provided in the car. Alternatively, for example, the camera may be provided vertically above or vertically below the landing plate of any of the floors in the hoistway.

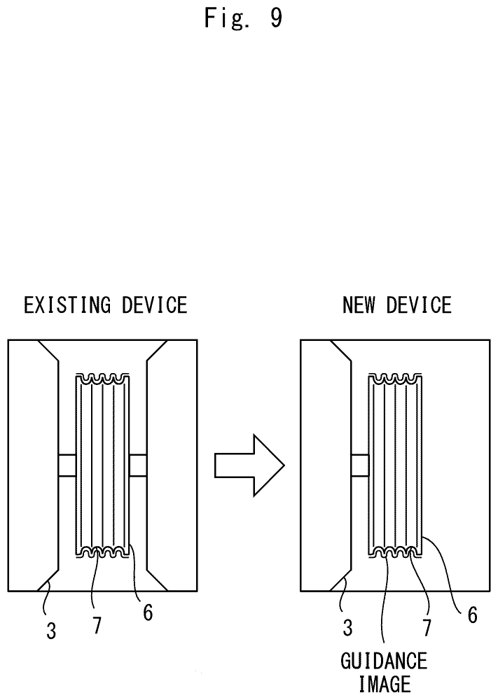

FIG. 9 is a diagram showing another example of display by the display unit 13 according to the first embodiment.

A left side of FIG. 9 shows an image of a state where the existing traction machine 3 is being arranged. A right side of FIG. 9 shows an image of a state where the new traction machine 3 is being arranged.

In this example, a size of the existing traction machine 3 differs from a size of the new traction machine 3. On the other hand, a size of the sheave 6 of the existing traction machine 3 is the same as a size of the sheave 6 of the new traction machine 3. In this case, the assistance system 1 can guide the arrangement of the new traction machine 3 according to a target arrangement based on an input with the sheave groove 7 of the existing traction machine 3 as a reference.

As described above, the assistance system 1 according to the first embodiment includes the image capturing apparatus 8 and the guidance system 9. The image capturing apparatus 8 captures an image of an area including a position of a target arrangement corresponding to each of one or more devices of an elevator. Arrangement work is work involving arranging each of the devices in a corresponding target arrangement. The guidance system 9 provides guidance for arrangement in the corresponding target arrangement of each of the devices based on the image captured by the image capturing apparatus 8.

The assistance system 1 provides guidance for arrangement work based on an image captured by the image capturing apparatus 8. Therefore, the assistance system 1 can be applied to arrangement work on a wide variety of devices of an elevator irrespective of types of the devices to be arranged, locations where the devices are to be arranged, and the like. In addition, since scribing and the like need not be performed in the arrangement work, the assistance system 1 can also be applied to arrangement work of devices that cannot be directly mounted to a building such as the sheave 6.

In addition, the guidance system 9 obtains a target arrangement corresponding to at least any of one or more devices based on an input by a worker to perform arrangement work.

Since the target arrangement is inputted by a worker to perform arrangement work, a target arrangement can be set in accordance with a state such as an arrangement location and a device to be arranged.

In addition, the guidance system 9 includes the display unit 13. The display unit 13 displays, with respect to at least any of one or more devices, a guidance image that indicates a target arrangement corresponding to the device by superimposing the guidance image on an image captured by the image capturing apparatus 8.

Accordingly, the worker can perform arrangement work while checking the device to be arranged and the guidance image at the same time. Therefore, the assistance system 1 can more effectively perform guidance of arrangement work.

Furthermore, the guidance image that indicates a target arrangement corresponding to at least any of one or more devices is an image of one or more feature portions of the device arranged in the target arrangement.

The assistance system 1 guides the arrangement work based on the feature portion of the device. Accordingly, a reference for positioning is made clear. Therefore, the assistance system 1 can more effectively perform guidance of arrangement work. In addition, even when the arrangement work includes a step of replacing an existing device with a new device that is different in an overall size, a shape, or the like from that of the existing device, a guidance of arrangement is performed more effectively based on a common feature portion that is shared between the existing device and the new device.

In addition, the guidance system 9 includes the notifying unit 14. In the notifying unit 14, with respect to at least any of one or more devices, a first range is set in advance with respect to a target arrangement corresponding to the device. The notifying unit 14 notifies that the device has entered the first range by first audio.

Accordingly, the worker can confirm an arrangement of the device without having to depend on a display by the display unit 13. In this case, the first range is a range that represents that, for example, when a position and an attitude of a device to be arranged are within the first range, the device has approached the target arrangement. Alternatively, the first range may be a range that represents that, for example, when a position and an attitude of a device to be arranged are within the first range, the device has been arranged in the target arrangement within a range of admissible error.

In addition, in the notifying unit 14, with respect to at least any device to which the first range is set among the one or more devices, a second range is set in advance with respect to the target arrangement corresponding to the device. The second range is included in the first range. The notifying unit 14 notifies that the device has entered the second range by second audio.

Accordingly, by being notified by different audio such as the first audio and the second audio, the worker can check an arrangement relationship between a device to be arranged and a target arrangement corresponding to the device. In this case, the second range is a range that represents that, for example, when a position and an attitude of a device to be arranged are within the second range, the device has been arranged in the target arrangement within a range of admissible error. Alternatively, the second range may be a range that includes a third range. The third range is a range that represents that, for example, when a position and an attitude of a device to be arranged are within the third range, the device has been arranged in the target arrangement within a range of admissible error.

In addition, the image capturing apparatus 8 is provided so as to be prevented from moving from start to finish of the arrangement work.

Accordingly, since the position of the image capturing apparatus 8 can be used as a reference, the assistance system 1 can more accurately guide arrangement work.

In addition, when the one or more devices in arrangement work include the traction machine 3, the image capturing apparatus 8 is arranged vertically above or arranged vertically below the sheave 6 of the traction machine 3.

Furthermore, when the one or more devices in arrangement work include a car door apparatus, the image capturing apparatus 8 is arranged on a rear wall of a cab of a car that is provided with the car door apparatus.

In this manner, since the image capturing apparatus 8 is arranged at a position suitable for guiding the arrangement of a device, the assistance system 1 can more accurately guide arrangement work.

Note that the target arrangement obtaining unit 12 may obtain a target arrangement corresponding to each device based on, for example, design information such as a design blueprint. For example, when the arrangement work is work for installing a new elevator, guidance to an arrangement in accordance with design information can be provided with respect to each device. In addition, the target arrangement obtaining unit 12 may obtain a target arrangement of a device to be arranged in arrangement work based on a relative arrangement with devices in a periphery of the device. For example, when the device to be arranged in arrangement work is the traction machine 3, the target arrangement of the traction machine 3 may be obtained based on a distance in a horizontal direction between the sheave groove 7 of the sheave 6 of the traction machine 3 and an edge of a rope duct of the machine room. Accordingly, the assistance system 1 can guide the sheave 6 to an arrangement that makes the hoisting rope 2 hanging down to the hoistway from the sheave groove 7 less likely to interfere with the edge of the rope duct. In this case, for example, when the arrangement work is replacement work or the like, a diameter of the sheave 6, the number of the sheave grooves 7, or the like may differ between before and after the replacement.

In addition, in arrangement work such as replacement work or maintenance checkup work of devices of an elevator, any of one or more devices may be arranged at a position from which a device of the elevator that had already been arranged prior to the replacement work has been removed. In this case, the target arrangement obtaining unit 12 may obtain a target arrangement corresponding to the device based on an arrangement prior to removal of the device that had already been arranged. For example, when the arrangement work includes a step of replacing the existing traction machine 3 with a new traction machine 3, the target arrangement obtaining unit 12 detects an arrangement of the sheave groove 7 of the existing traction machine 3 prior to removal by image recognition of an image of the existing traction machine 3 having been captured by an image capturing unit. Based on the obtained position of the sheave groove 7, the target arrangement obtaining unit 12 obtains the target arrangement of the new traction machine 3 on the assumption that, for example, the position of the sheave groove 7 is unchanged between before and after the replacement. In this case, the worker need not input a target arrangement from the input unit 11. Accordingly, workability of arrangement work improves. Note that in maintenance checkup work of devices of an elevator or the like, a given device that had already been arranged prior to arrangement work and a device to be arranged at a position and an attitude of the given device in the arrangement work may be the same device.

In addition, the storage unit 10 stores an order set in advance of an arrangement of one or more devices in arrangement work. In this case, the target arrangement obtaining unit 12 may obtain, with respect to at least any of the one or more devices, a target arrangement corresponding to the device based on a relative arrangement of a device arranged prior to the device in the order stored in the storage unit 10. In this case, the target arrangement obtaining unit 12 determines whether or not the device is arranged according to the order stored in the storage unit 10. When an order of arrangement of the device conforms to the order stored in the storage unit 10, the target arrangement obtaining unit 12 obtains a target arrangement based on a relative arrangement of the device. For example, when the motor 5 and the sheave 6 of the traction machine 3 are separately arranged in this order in arrangement work, the target arrangement obtaining unit 12 obtains a target arrangement of the sheave 6 based on a position or an attitude of arrangement of the motor 5. The storage unit 10 may store information on the relative arrangement of the motor 5 and the sheave 6 of the traction machine 3. In this case, the target arrangement obtaining unit 12 may obtain a target arrangement of the sheave 6 from the position or the attitude of the arranged motor 5 by referring to the relative arrangement of the sheave 6 in the storage unit 10. In this case, an occurrence of interference with devices that have already been arranged and the like are suppressed.

Next, a specific example of extraction of a feature portion of a device will be described with reference to FIGS. 10 to 12.

FIGS. 10 to 12 are diagrams showing an example of extraction of a feature portion by the target arrangement obtaining unit 12 according to the first embodiment.

In this example, the target arrangement obtaining unit 12 performs an extraction of a feature portion using, for example, an image processing method such as template matching. As a feature portion of a device, for example, the target arrangement obtaining unit 12 extracts a corner of a contour of the device that is an example of a point indicating a position, an attitude, and the like of the device.

FIG. 10 shows a captured image of a device captured by the image capturing apparatus 8 and a model image of the device. The model image of the device is, for example, a similar image of the device captured in the past, a similar image generated based on design information of the device or the like, and the like. An example of a similar image based on design information is a CAD image (CAD: Computer Aided Design). Note that a feature portion of a device in a model image of the device is known.

The target arrangement obtaining unit 12 detects a position of a device on a captured image that is captured by the image capturing apparatus 8 by scanning a model image on the captured image. The target arrangement obtaining unit 12 may scan the model image while performing image transformation such as an affine transformation including enlarging, reducing, and rotating the model image or a homography transformation. While scanning the model image, the target arrangement obtaining unit 12 calculates a degree of similarity, a degree of difference, or the like with the model image with respect to a range on the captured image on which the model image is superimposed.

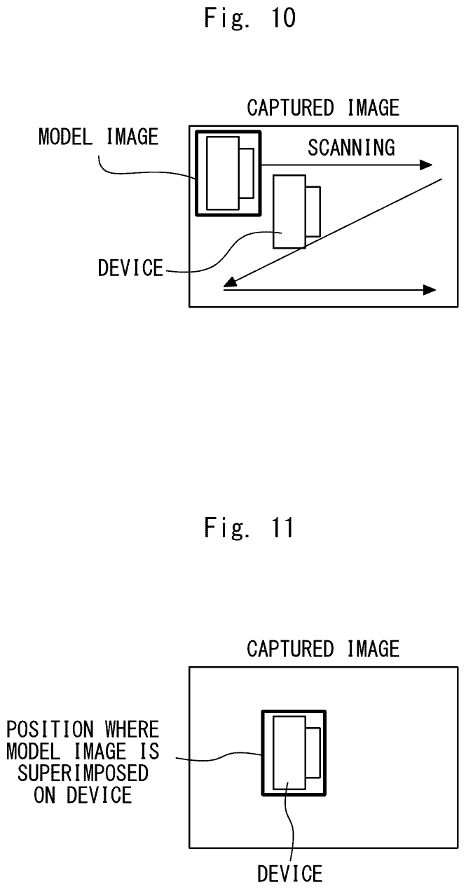

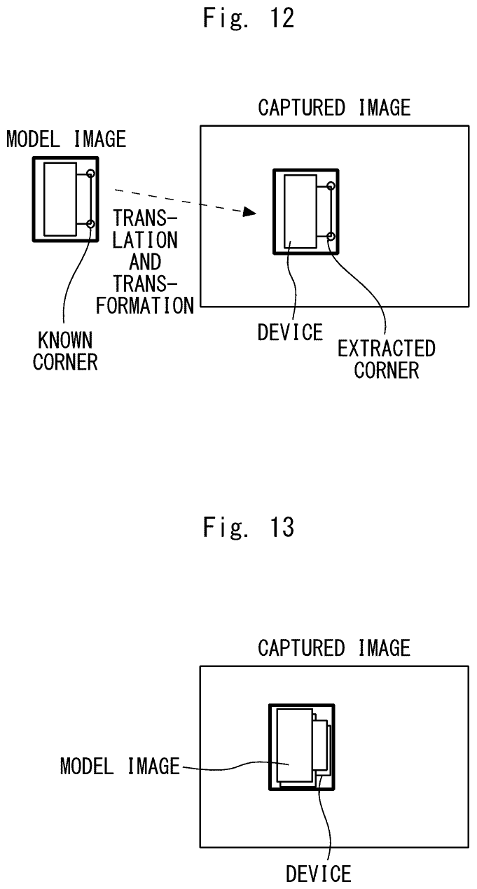

Next, as shown in FIG. 11, the target arrangement obtaining unit 12 detects a position where the degree of similarity is maximized, a position where the degree of difference is minimized, or the like as a position of a device on the captured image. When performing a transformation such as a rotation, an enlargement, a reduction, or the like of the model image during scanning, the target arrangement obtaining unit 12 may also detect a parameter of the transformation such as an angle of rotation, a multiplying factor of enlargement or reduction, or the like of the model image.

Next, as shown in FIG. 12, the target arrangement obtaining unit 12 adopts an arrangement of the feature portion of the model image arranged at a position detected by scanning or the like as an arrangement of the feature portion of the device on the captured image. Since the feature portion in the model image is known, the target arrangement obtaining unit 12 can extract an arrangement of the feature portion of the device on the captured image using the position of the model image detected by scanning and parameters of the transformation.

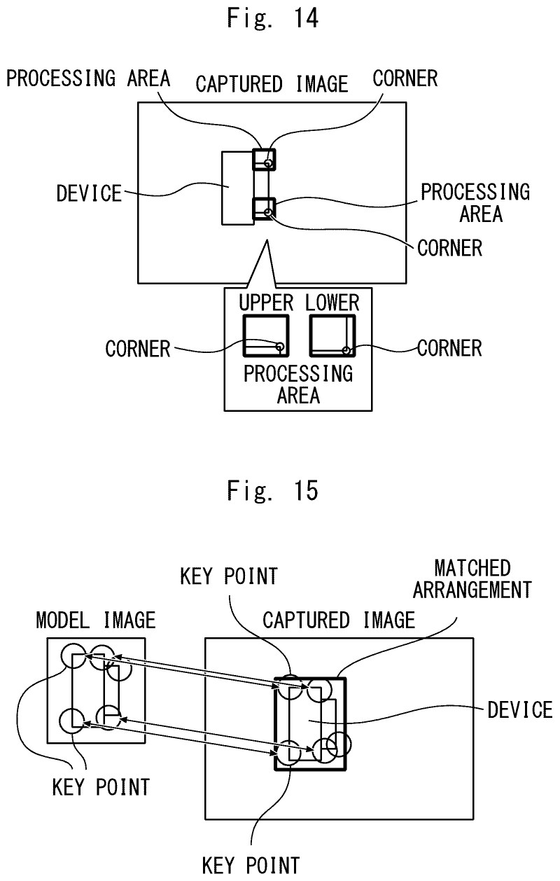

Next, another specific example of extraction of a feature portion of a device will be described with reference to FIGS. 13 and 14.

FIGS. 13 and 14 are diagrams showing another example of extraction of a feature portion by the target arrangement obtaining unit 12 according to the first embodiment.

As shown in FIG. 13, an image of a device on a captured image and a model image may not be exactly the same. In such a case, the target arrangement obtaining unit 12 detects a general position of the device on the captured image by scanning the model image.

Subsequently, as shown in FIG. 14, the target arrangement obtaining unit 12 sets a processing area where detailed detection of the feature portion is to be performed in an area including the arrangement of the feature portion of the model image arranged at a position detected by scanning or the like. In this example, the target arrangement obtaining unit 12 sets two processing areas, namely an upper processing area and a lower processing area.

The target arrangement obtaining unit 12 performs detection processing of a corner in each of the set processing areas. In the detection processing of a corner, for example, a known algorithm such as the Harris corner detector or the Shi-Tomasi corner detector can be applied. The target arrangement obtaining unit 12 extracts a corner detected in this manner as a feature portion.

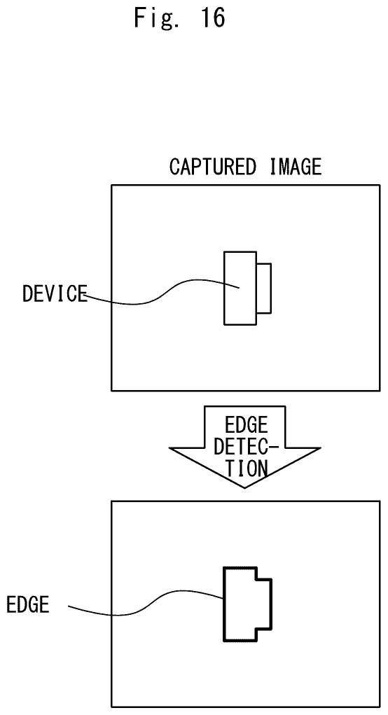

Next, another specific example of extraction of a feature portion of a device will be described with reference to FIG. 15.

FIG. 15 is a diagram showing another example of extraction of a feature portion by the target arrangement obtaining unit 12 according to the first embodiment.

The target arrangement obtaining unit 12 calculates an image feature amount in each of a model image and a captured image. The image feature amount calculated in this case is, for example, SIFT (Scale-Invariant Feature Transform), SURF (Speed Up Robust Feature), or HOG (Histogram of Oriented Gradient). The image feature amount calculated at this point is a rotationally-invariant and scale-invariant feature amount. For example, FIG. 15 shows a key point detected by a feature amount such as SIFT.

The target arrangement obtaining unit 12 performs matching of a key point detected in a model image and a key point detected in a captured image. Accordingly, the target arrangement obtaining unit 12 can detect a position of a device on a captured image. Even when the device has been rotated, enlarged, or reduced on the captured image, matching is made possible by using a rotationally-invariant and scale-invariant feature amount.

For example, the target arrangement obtaining unit 12 adopts an arrangement of the feature portion of the model image having been matched in this manner as an arrangement of the feature portion of the device on the captured image. Alternatively, the target arrangement obtaining unit 12 may set a processing area where detailed detection of the feature portion is to be performed in an area including the arrangement of the feature portion of the model image having been matched in this manner. In this case, by performing detection processing of a corner in each of the set processing areas, the target arrangement obtaining unit 12 extracts a detected corner as the feature portion.

As shown in FIG. 16, as a feature portion of a device, the target arrangement obtaining unit 12 may extract an edge of a contour of the device that is an example of a line indicating a position, an attitude, and the like of the device. FIG. 16 is a diagram showing another example of extraction of a feature portion by the target arrangement obtaining unit 12 according to the first embodiment. The target arrangement obtaining unit 12 extracts an edge as a feature portion in a procedure similar to that followed when extracting a corner as a feature portion. In this case, in the detection processing of an edge, for example, a known algorithm such as the Canny edge detector can be applied. In the detection processing of an edge, processing such as denoising and segmentalization may be performed. Since a more readily intuitively understandable edge is displayed as a guidance image, a worker can more readily perform arrangement work of the device.

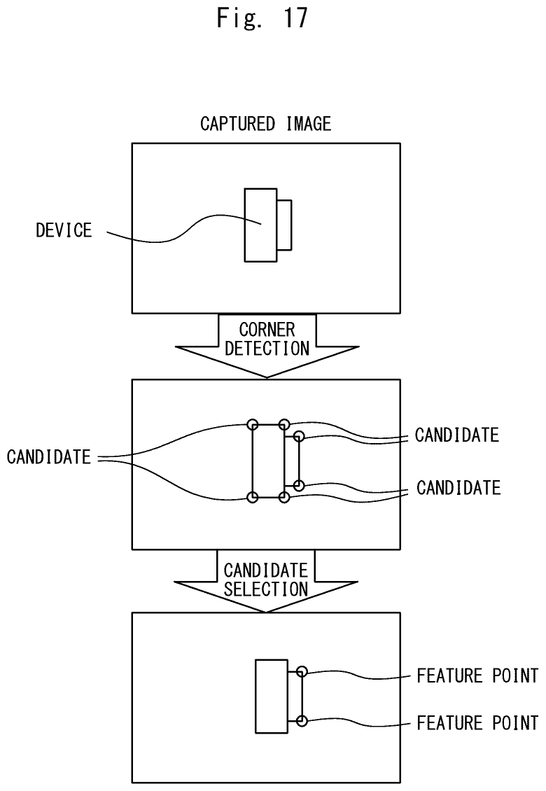

In addition, as shown in FIG. 17, the target arrangement obtaining unit 12 may obtain a plurality of candidates of a target arrangement of a device based on an image of the device captured by the image capturing apparatus 8. FIG. 17 is a diagram showing an example of obtaining a target arrangement by the target arrangement obtaining unit 12 according to the first embodiment. A candidate of a target arrangement of a device is, for example, a candidate of a feature portion of the device. In this example, the candidate of the feature portion is, for example, a plurality of corners extracted by an image processing method.

In this case, the guidance system 9 presents a worker with a plurality of candidates of the target arrangement through, for example, the display unit 13. Using the input unit 11 or the like, the worker selects one or a plurality of candidates from the plurality of presented candidates of the target arrangement. The target arrangement obtaining unit 12 obtains the candidate selected by the worker as a target arrangement of the device. In this example, candidates not selected by the worker are removed from the target arrangement of the device. Accordingly, a target arrangement can be more readily inputted by the worker.

Furthermore, the guidance image that indicates a target arrangement corresponding to at least any of one or more devices may be an image of the device arranged in the target arrangement. For example, when the arrangement work includes a step of replacing the existing traction machine 3 with a new traction machine 3, the display unit 13 may display, as a guidance image, an image of the existing traction machine 3 prior to being removed by superimposing the image on an image of the new traction machine 3 having been arranged in arrangement work. In this case, the image of the existing traction machine 3 that is the guidance image is displayed superimposed as, for example, a translucent image so as to allow a comparison with a position of the image of the new traction machine 3 to be performed. Alternatively, the image of the existing traction machine 3 that is the guidance image may be displayed superimposed as, for example, an image solely constituted of a contour.

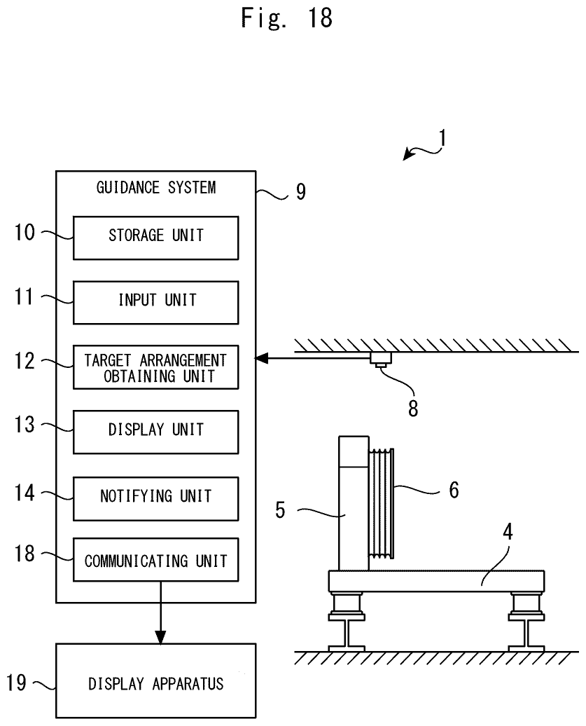

FIG. 18 is a configuration diagram of the assistance system 1 according to a modification of the first embodiment.

The guidance system 9 includes a communicating unit 18. The communicating unit 18 is a portion that outputs information to a device outside of the guidance system 9 in a wired or wireless manner. The communicating unit 18 may output information to an external device through a communication network such as the Internet. For example, the communicating unit 18 outputs information on a target arrangement or information on a guidance image. For example, the communicating unit 18 outputs information to a display apparatus 19 outside of the guidance system 9. The display apparatus 19 may be a portable information terminal such as a smartphone that is carried by, for example, a worker. In addition, the worker may wear the display apparatus 19 during arrangement work. For example, the display apparatus 19 is an apparatus such as an HMD (Head Mounted Display) that displays an inputted image by superimposing the inputted image on an image of a field of view of the worker. The display apparatus 19 displays an image using, for example, AR technology (AR: Augmented Reality) or VR technology (VR: Virtual Reality). Accordingly, since the worker can check an arrangement relationship between a device and a target arrangement while performing arrangement work, work efficiency of the arrangement work can be improved. Note that the information on a target arrangement or a guidance image may be information obtained based on images captured by a plurality of cameras of the image capturing apparatus 8 as three-dimensional information.

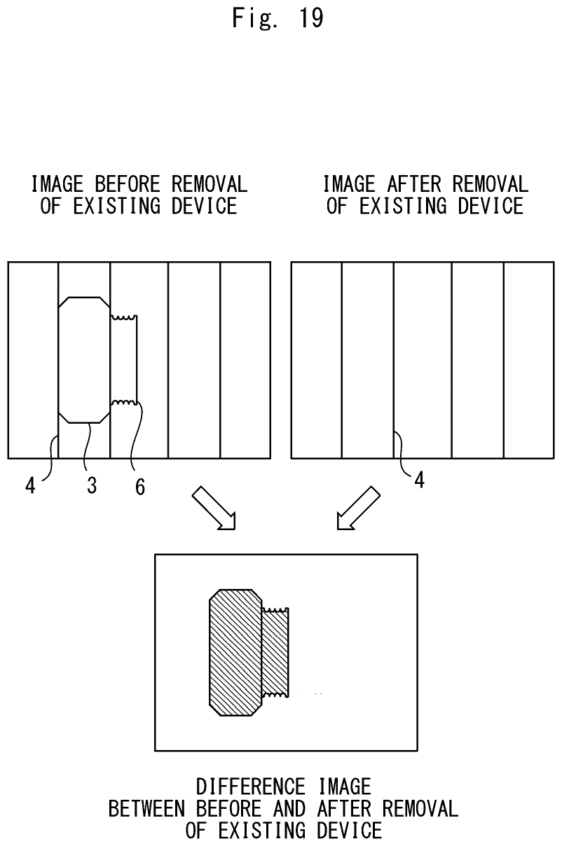

FIG. 19 is a diagram showing an example of obtaining a target arrangement by the target arrangement obtaining unit 12 according to another modification of the first embodiment.

As shown in FIG. 19, the target arrangement obtaining unit 12 obtains a target arrangement based on an image having been captured by the image capturing apparatus 8 prior to removal of a device that had already been arranged and an image captured by the image capturing apparatus 8 after the removal of the device. For example, when the arrangement work includes a step of replacing the existing traction machine 3 with a new traction machine 3, the target arrangement obtaining unit 12 obtains an image of the existing traction machine 3 prior to removal. In addition, the target arrangement obtaining unit 12 obtains an image after the removal of the existing traction machine 3. By calculating a difference between the obtained images, the target arrangement obtaining unit 12 extracts a position or an attitude of the existing traction machine 3 in an image captured by the image capturing apparatus 8. Based on the extracted position of the existing traction machine 3, the target arrangement obtaining unit 12 obtains a target arrangement corresponding to a position or an attitude of the new traction machine 3.

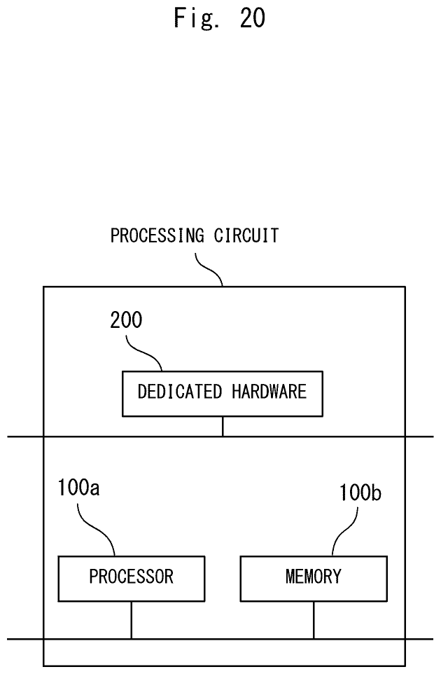

Next, an example of a hardware configuration of the assistance system 1 will be described with reference to FIG. 20.

FIG. 20 is a hardware configuration diagram of substantial parts of the assistance system 1 according to the first embodiment.

Each function of the assistance system 1 can be realized by a processing circuit. The processing circuit includes at least one processor 100a and at least one memory 100b. The processing circuit may include at least one piece of dedicated hardware 200 together with, or in place of, the processor 100a and the memory 100b.

When the processing circuit includes the processor 100a and the memory 100b, each function of the assistance system 1 is realized by software, firmware, or a combination of software and firmware. At least one of the software and the firmware is described as a program. The program is stored in the memory 100b. The processor 100a realizes each function of the assistance system 1 by reading and executing the program stored in the memory 100b.

The processor 100a is also referred to as a CPU (Central Processing Unit), a processing unit, an arithmetic unit, a microprocessor, a microcomputer, or a DSP. The memory 100b is constituted of, for example, a non-volatile or volatile semiconductor memory such as a RAM, a ROM, a flash memory, an EPROM, or an EEPROM.

When the processing circuit includes the piece of dedicated hardware 200, for example, the processing circuit is realized by a single circuit, a combined circuit, a programmed processor, a parallel-programmed processor, an ASIC, an FPGA, or a combination thereof.

Each function of the assistance system 1 can be individually realized by a processing circuit. Alternatively, respective functions of the assistance system 1 can be collectively realized by a processing circuit. With respect to the respective functions of the assistance system 1, a part of the functions may be realized by the piece of dedicated hardware 200 while other parts may be realized by software or firmware. In this manner, the processing circuit realizes each function of the assistance system 1 using the piece of dedicated hardware 200, software, firmware, or a combination thereof.

### Second Embodiment

The assistance system 1 according to the first embodiment obtains a target arrangement corresponding to the traction machine 3 based on an input from a worker. The assistance system 1 according to a second embodiment learns, by machine learning, a relationship between an image captured by the image capturing apparatus 8 and a target arrangement inputted by a worker in the past through the input unit 11 on the image. In addition, the assistance system 1 infers, using a trained model generated by learning, a target arrangement in an image captured by the image capturing apparatus 8.

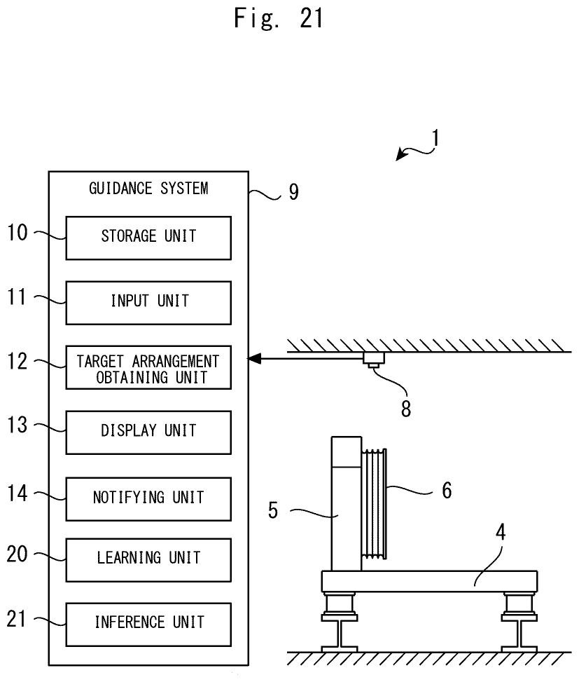

FIG. 21 is a configuration diagram of the guidance system 9 according to the second embodiment. The guidance system 9 according to the second embodiment further includes a learning unit 20 and an inference unit 21.

The learning unit 20 obtains, as data for learning, a set of an image captured by the image capturing apparatus 8 and a target arrangement inputted by a worker in the past through the input unit 11 with respect to the image. In this case, the data for learning is data that associates the image captured by the image capturing apparatus 8 and the target arrangement inputted by a worker with respect to the image with each other. Based on the obtained data for learning, the learning unit 20 learns a target arrangement in the image captured by the image capturing apparatus 8. In other words, the learning unit 20 generates a trained model for inferring an optimal target arrangement from the image captured by the image capturing apparatus 8. Note that the image captured by the image capturing apparatus 8 is, for example, an image of an area where a device is to be arranged as captured from vertically above in a similar manner to the first embodiment. In this case, a combination of data included in the data for learning depends on steps of arrangement work. For example, in a step of newly arranging a device, the image captured by the image capturing apparatus 8 is an image that does not include the device. Therefore, a combination of the image captured by the image capturing apparatus 8 and the target arrangement inputted by a worker with respect to the image is obtained as data for learning. In addition, in a step of replacing an existing device with a new device, the image captured by the image capturing apparatus 8 is an image that includes the existing device. Therefore, a combination of the image captured by the image capturing apparatus 8 and the target arrangement inputted by a worker with respect to the image is obtained as data for learning.

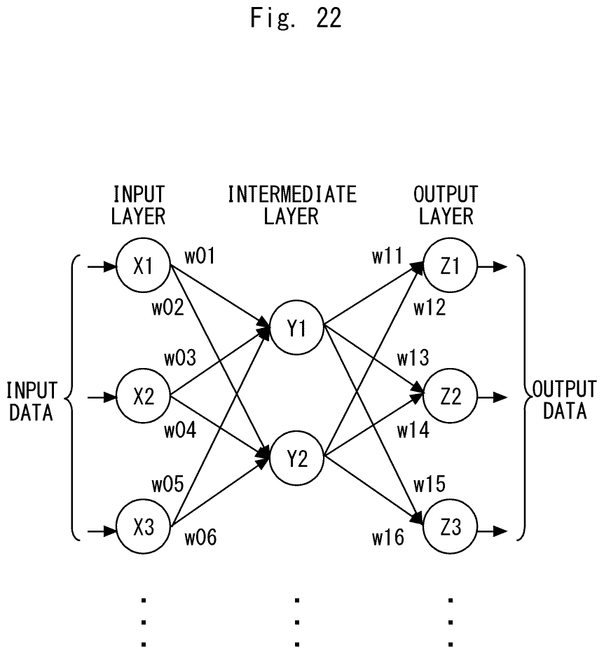

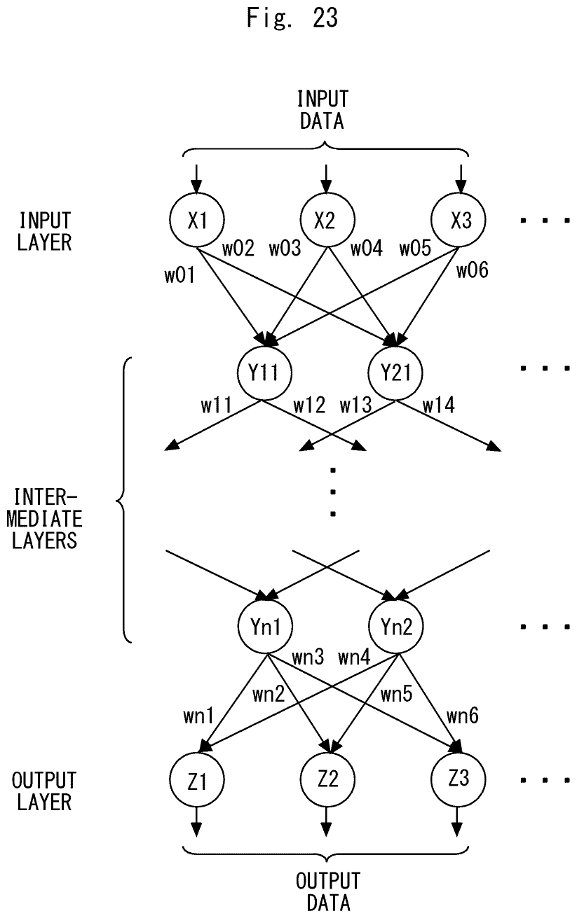

Next, an example of a trained model that is learned in the learning unit 20 will be described with reference to FIGS. 22 and 23. FIGS. 22 and 23 are diagrams showing an example of a trained model in the learning unit 20 according to the second embodiment. The learning unit 20 can learn using a known learning algorithm such as supervised learning and reinforcement learning. As an example, a learning algorithm based on supervised learning using a neural network will be described. In this example, the learning unit 20 learns a target arrangement with respect to image data of the existing traction machine 3 by supervised learning according to a neural network model. In this case, supervised learning refers to a method of generating a trained model by providing a learning apparatus such as the learning unit 20 with a set of data of input and output and learning a feature of the pieces of data for learning. The trained model that is generated at this point is used by an inference apparatus such as the inference unit 21 to infer an output from an input.

A neural network is constituted of an input layer made up of a plurality of neurons, an intermediate layer made up of a plurality of neurons, and an output layer made up of a plurality of neurons. In each of the neurons, an activation function is applied to an inputted value to produce an output. For example, the activation function is a non-linear function such as a sigmoid function or a ramp function.

For example, in a case of a 3-layer neural network such as that shown in FIG. 22, when a plurality of inputs are inputted to input layer (X1, X2, X3, . . . ), output values thereof are multiplied by weights W0 (w01, w02, w03, . . . ) and inputted to intermediate layer (Y1, Y2, . . . ). Output values from the intermediate layer are further multiplied by weights W1 (w11, w12, w13, . . . ) and inputted to output layer (Z1, Z2, Z3, . . . ). Each neuron of the output layer outputs output data based on the inputted value. In this manner, an output of the neural network changes depending on a value of each component of weight vectors W0 and W1. In this example, the trained model is represented by the weight vectors W0 and W1.

Alternatively, as shown in FIG. 23, a learning algorithm using a neural network including two or more intermediate layers may be applied. In a case of such a neural network, when a plurality of inputs are inputted to input layer (X1, X2, X3, . . . ), output values thereof are multiplied by weights W0 (w01, w02, w03, . . . ) and inputted to first intermediate layer (Y11, Y12, . . . ). Output values from the first intermediate layer are further multiplied by weights W1 (w11, w12, w13, . . . ) and inputted to second intermediate layer. This operation is similarly repeated to further multiply output values from n-th intermediate layer by weights Wn (wn1, wn2, wn3, . . . ), the integer n denoting a natural number equal to or greater than 2, and inputted to output layer. Each neuron of the output layer outputs output data based on the inputted value. In this manner, an output of the neural network changes depending on a value of each component of weight vectors W0, W1, . . . , Wn. In this example, the trained model is represented by the weight vectors W0, W1, . . . , Wn. Note that a connection between adjacent layers need not be a full connection. For example, the neural network may include a convolutional layer. In addition, the neural network may include a pooling layer.

Data to be inputted to the input layer is, for example, a feature amount of an image extracted from the image. For example, the feature amount of an image includes a position of an edge in the image. For example, the data to be inputted to the input layer may include information such as a label that specifies a type of a device to be arranged in a target arrangement. Data to be outputted from the output layer is, for example, a position and an attitude that represent a target arrangement of a device. When a target arrangement is labelable, the data to be outputted from the output layer may be a value such as a probability at which each label is to be attached as a target arrangement.

In the second embodiment, the neural network of the learning unit 20 learns, by so-called supervised learning, a target arrangement in image data captured by the image capturing apparatus 8 according to data for learning created based on a combination of an image captured by the image capturing apparatus 8 and a target arrangement inputted by a worker in the past through the input unit 11 on the image. In other words, the neural network learns by adjusting weight vectors W0, W1, and the like so that an output from the output layer as a result of inputting an image captured by the image capturing apparatus 8 to the input layer or, in other words, a target arrangement approaches a target arrangement inputted by a worker in the past through the input unit 11. The learning unit 20 can learn from data for learning by known methods such as error back propagation.

The learning unit 20 generates the trained model by executing learning such as that described above. The storage unit 10 stores the trained model generated by the learning unit 20.

While a case where supervised learning is applied to the learning algorithm used by the learning unit 20 has been described, the learning algorithm used by the learning unit 20 is not limited thereto. The learning algorithm need only be able to learn a relationship between an image captured by the image capturing apparatus 8 and a target arrangement and machine learning may be performed using other known methods such as genetic programming, functional logic programming, and support vector machine. In addition, deep learning that learns extraction itself of a feature amount of an image may be used as the learning algorithm to be used by the learning unit 20. Furthermore, the learning unit 20 may learn the relationship between an image captured by the image capturing apparatus 8 and a target arrangement using an algorithm such as reinforcement learning. A reward in reinforcement learning may be, for example, an assessment inputted by a worker or the like after work, a period of time or the number of steps required by the work, or the like.

In addition, data to be inputted to the input layer may be image data itself. The image data inputted during learning by the learning unit 20 may include a CG image (CG: Computer Graphics) generated using a three-dimensional CAD or the like in addition to an image captured by the image capturing apparatus 8. The image data inputted during learning may be converted so that the CG image resembles a real image captured by the image capturing apparatus 8. In this case, the image data inputted during learning is generated using a technique such as GAN (Generative Adversarial Network). In this case, for example, a network that generates a similar image for learning is used as a generative network in the GAN. In addition, a network that discriminates between a real image captured by the image capturing apparatus 8 and a similar image generated by the generative network is used as a discriminator network. By increasing the number of images for learning in this manner, accuracy of learning by the learning unit 20 can be enhanced. Note that data of a target arrangement with respect to image data generated in this manner may be manually set by a worker or the like or automatically set based on information on components of three-dimensional CAD data to be a source of a CG image or the like.

The inference unit 21 infers a target arrangement obtained using the trained model in an image captured by the image capturing apparatus 8. In other words, the target arrangement inferred from an image captured by the image capturing apparatus 8 can be outputted by inputting the image to the trained model.

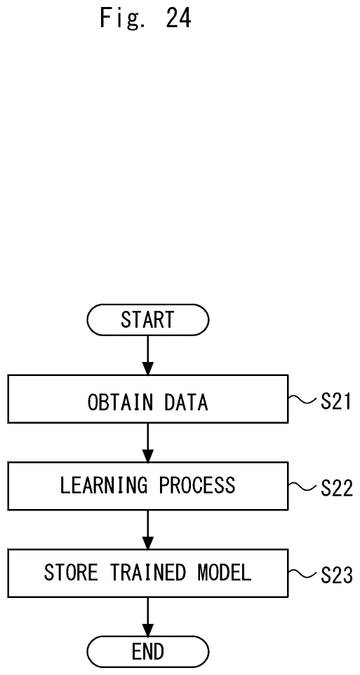

Next, an example of processing of learning by the learning unit 20 will be described with reference to FIG. 24. FIG. 24 is a flowchart showing an example of operations of the assistance system 1 according to the second embodiment. FIG. 24 shows an example of processing of learning in the learning unit 20.

In this case, the assistance system 1 according to the second embodiment uses an image of the existing traction machine 3 obtained by an operation of the assistance system 1 shown in FIG. 6 and a target arrangement inputted by a worker as data for learning. The learning processing described below may be performed after the processing shown in FIG. 6 has been performed a plurality of times. In addition, the learning processing described below may be performed every time the processing shown in FIG. 6 has been performed once and, subsequently, this pattern may be repeated.

In step S21, the learning unit 20 obtains data for learning that is created based on a combination of an image captured by the image capturing apparatus 8 and a target arrangement inputted by a worker in the past through the input unit 11 with respect to the image. While the learning unit 20 is configured to simultaneously obtain the image of the existing traction machine 3 and the target arrangement in the second embodiment, the learning unit 20 need only be able to input the image of the existing traction machine 3 and the target arrangement in association with each other and the learning unit 20 may obtain the image of the existing traction machine 3 and data on the target arrangement at respectively different timings.

Subsequently, in step S22, the learning unit 20 learns, by supervised learning, a target arrangement of a device in image data captured by the image capturing apparatus 8 according to data for learning created based on the combination of an image captured by the image capturing apparatus 8 and a target arrangement inputted by a worker in the past through the input unit 11 with respect to the image and generates a trained model.

Subsequently, in step S23, the storage unit 10 stores the trained model generated by the learning unit 20.

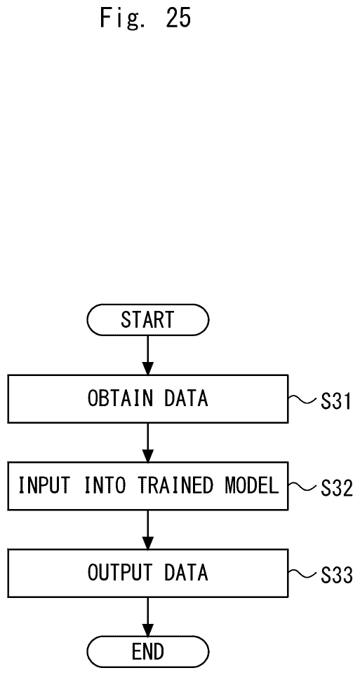

Next, an example of processing of inference in the inference unit 21 of a target arrangement with respect to an image captured by the image capturing apparatus 8 will be described with reference to FIG. 25. FIG. 25 is a flowchart showing an example of operations of the assistance system 1 according to the second embodiment. FIG. 25 shows an example of processing of inference in the inference unit 21. In the second embodiment, an operation related to the processing of inference is performed in step S11 in FIG. 6 and subsequent operations are similar to the operations shown in FIG. 6.

In step S31, the inference unit 21 obtains an image captured by the image capturing apparatus 8.

Subsequently, in step S32, the inference unit 21 inputs the image captured by the image capturing apparatus 8 into the trained model stored in the storage unit 10. The inference unit 21 obtains a target arrangement with respect to the image data captured by the image capturing apparatus 8 from an output of the trained model.

Subsequently, in step S33, the inference unit 21 outputs the target arrangement with respect to the image data captured by the image capturing apparatus 8 obtained by the trained model. The target arrangement is a target arrangement of any of the devices of the elevator that is arranged in an area of the image in arrangement work. The target arrangement obtaining unit 12 obtains the target arrangement outputted by the inference unit 21 as a target arrangement of the device. Subsequently, the operation of the assistance system 1 advances to step S12 in FIG. 6 and the outputted target arrangement is displayed superimposed on the image captured by the image capturing apparatus 8.

As described above, the assistance system 1 according to the second embodiment includes the learning unit 20. Using data for learning, the learning unit 20 generates a trained model by machine learning. The data for learning includes an image captured by the image capturing apparatus 8 and a target arrangement of a device to be arranged in an area of the image among devices of the elevator. The trained model is used to infer a target arrangement from the image captured by the image capturing apparatus 8. In addition, the assistance system 1 includes the inference unit 21. The inference unit 21 infers, using the trained model, a target arrangement of the device from an image captured by the image capturing apparatus. The guidance system 9 obtains the target arrangement corresponding to the device based on an inference by the inference unit 21. Due to such a configuration, a worker need no longer input a target arrangement through the input unit 11 and an effect of reducing a burden on the worker of inputting a target arrangement, an effect of enabling even a person without experience to specify a target arrangement, and the like can be produced.

While the inference unit 21 has been described to output a target arrangement with respect to image data captured by the image capturing apparatus 8 using the trained model generated by the learning unit 20 of the assistance system 1 in the second embodiment, alternatively, the inference unit 21 may obtain a trained model generated by an external system (not illustrated) of the assistance system 1 and output a target arrangement with respect to image data captured by the image capturing apparatus 8 using the trained model obtained from the external system.

In addition, one of or both of the learning unit 20 and the inference unit 21 may be mounted to an apparatus which is arranged outside the building in which the elevator is provided and to which a connection is established through a communication network such as the Internet. For example, the learning unit 20 may be mounted to a learning apparatus as an independent apparatus. Furthermore, the inference unit 21 may be mounted to an inference apparatus as an independent apparatus. In addition, one of or both of the learning unit 20 and the inference unit 21 may be mounted to a virtual machine on a cloud service or the like.

In addition, the learning unit 20 may perform learning using data for learning created in a plurality of elevators. In this case, the plurality of elevators may be provided in mutually different buildings. Furthermore, the plurality of elevators may be elevators that are operated in a same area. Alternatively, the plurality of elevators may be elevators that are operated in a plurality of areas. An elevator that is considered a target of obtaining data for learning in the learning unit 20 may be added or removed while the assistance system 1 is operating. In addition, the learning unit 20 of a given assistance system 1 may obtain a trained model generated by the learning unit 20 of another assistance system 1. In this case, the learning unit 20 of the given assistance system 1 having obtained the trained model may perform relearning so as to update the obtained trained model using data for learning that is obtained in the given assistance system 1.

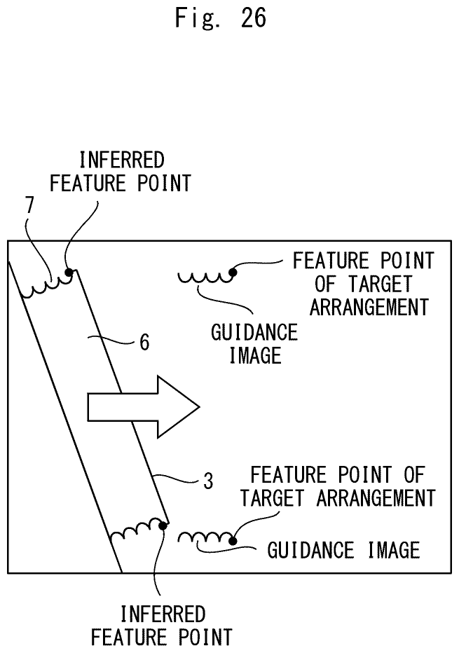

Next, a modification of the second embodiment will be described with reference to FIG. 26.

FIG. 26 is a diagram showing an example of display by the display unit 13 according to the modification of the second embodiment. In this modification, a trained model is a model capable of inferring, in addition to a target arrangement of a device to be arranged in an area of an image captured by the image capturing apparatus 8, a feature portion of the device from the image. The feature portion of the device that is inferred in the trained model is one or a plurality of feature portions.

Hereinafter, arrangement work for arranging the traction machine 3 will be described as an example. In this example, an existing traction machine is to be replaced with a new traction machine 3. In the arrangement work, after the existing traction machine is removed, the new traction machine 3 is temporarily placed in a vicinity of a target arrangement. At this point, the image capturing apparatus 8 captures an image of an area that includes both the temporarily-placed new traction machine 3 and a position of a target arrangement of the new traction machine 3.

The learning unit 20 obtains, as data for learning, a set of an image captured by the image capturing apparatus 8, a target arrangement of the new traction machine 3 inputted by a worker in the past through the input unit 11 with respect to the image, and a feature portion of the temporarily-placed new traction machine 3 in the image. For example, the feature portion of the new traction machine 3 is inputted by a worker through the input unit 11. For example, the feature portion of the new traction machine 3 may be inputted together with a target arrangement. The trained model in the learning unit 20 may be a composite model that independently includes a model for obtaining a target arrangement and a model for obtaining a feature portion. In this case, the learning unit 20 may independently obtain data for learning for the model for obtaining a target arrangement and data for learning for the model for obtaining a feature portion.

Using the trained model by the learning unit 20, the inference unit 21 infers, from an image captured by the image capturing apparatus 8, a target arrangement of the new traction machine 3 and a feature portion of the temporarily-placed new traction machine 3 in the image. In the guidance system 9, based on the target arrangement and the feature portion of the new traction machine 3 having been inferred in this manner, guidance of the new traction machine 3 to the target arrangement is performed. For example, as shown in FIG. 26, the display unit 13 displays a guidance image by superimposing the guidance image on an image captured by the image capturing apparatus 8. In this example, an image showing a position and an attitude of the sheave 6 of the new traction machine 3 arranged in the target arrangement is shown as the guidance image. In the image, a position of the feature portion when the new traction machine 3 is arranged in the target arrangement is shown. Furthermore, as a guidance image, a position of the feature portion of the new traction machine 3 to be arranged in the target arrangement from the temporarily-placed position is shown. According to such a configuration, since the feature portion of the present device and the feature portion of the device arranged in the target arrangement are simultaneously displayed, the assistance system 1 can provide guidance of arrangement work in a more effective manner. Therefore, workability of arrangement work can be improved.

### INDUSTRIAL APPLICABILITY

The assistance system according to the present disclosure can be applied to arrangement work of devices of an elevator.

### REFERENCE SIGNS LIST

1 Assistance system, 2 Hoisting rope, 3 Traction machine, 4 Traction
machine table, 5 Motor, 6 Sheave, 7 Sheave groove, 8 Image capturing apparatus,
9 Guidance system, 10 Storage unit, 11 Input unit, 12 Target arrangement obtaining
unit, 13 Display unit, 14 Notifying unit, 15 Landing sill, 16 Landing device, 17
Detection unit, 18 Communicating unit, 19 Display apparatus, 20 Learning unit,
21 Inference unit, 100a Processor, 100b Memory, 200 Dedicated hardware

1. An assistance system for arrangement work on devices of an elevator, comprising:
a camera system that, in arrangement work of arranging each of one or more devices of the elevator in a corresponding target arrangement, captures an image of an area including a position of a target arrangement corresponding to each of the one or more devices; and
processing circuitry that provides guidance for arrangement in the corresponding target arrangement of each of the one or more devices based on the image captured by the camera system.

2. The assistance system for arrangement work on devices of an elevator according to claim 1, wherein
the processing circuitry stores an order set in advance of arrangement of the one or more devices in the arrangement work, determines whether at least any of the one or more devices is being arranged according to the stored order, and when an order of the arrangement conforms to the stored order, obtains a target arrangement corresponding to the device based on a relative arrangement of a device to be arranged prior to the device in the stored order.

3. The assistance system for arrangement work on devices of an elevator according to claim 1, wherein
the processing circuitry obtains, when at least any of the one or more devices is to be arranged at a position after removing a device of the elevator that had already been arranged prior to the arrangement work, a target arrangement corresponding to the device based on an arrangement prior to removal of the device that had already been arranged.

4. The assistance system for arrangement work on devices of an elevator according to claim 1, wherein
the processing circuitry obtains a target arrangement based on a difference between an image having been captured by the camera system prior to removal of a device that had already been arranged and an image captured by the camera system after the removal of the device.

5. The assistance system for arrangement work on devices of an elevator according to claim 1, wherein
the processing circuitry obtains a target arrangement corresponding to at least any of the one or more devices based on an input by a worker to perform the arrangement work.

6. The assistance system for arrangement work on devices of an elevator according to claim 5, wherein
the processing circuitry obtains a target arrangement corresponding to at least any of the one or more devices based on a candidate selected by a worker to perform the arrangement work from a plurality of candidates presented to the worker by the processing circuitry.

7. The assistance system for arrangement work on devices of an elevator according to claim 1, comprising:
a display that displays, with respect to at least any of the one or more devices, a guidance image that indicates a target arrangement corresponding to the device by superimposing the guidance image on an image captured by the camera system.

8. The assistance system for arrangement work on devices of an elevator according to claim 1, wherein
the processing circuitry outputs, with respect to at least any of the one or more devices, a guidance image that indicates a target arrangement corresponding to the device to a display that displays an inputted image by superimposing the inputted image on an image of a field of view of a worker to perform the arrangement work.

9. The assistance system for arrangement work on devices of an elevator according to claim 7, wherein
the guidance image that indicates a target arrangement corresponding to at least any of the one or more devices is an image of the device arranged in the target arrangement.

10. The assistance system for arrangement work on devices of an elevator according to claim 7, wherein
the guidance image that indicates a target arrangement corresponding to at least any of the one or more devices is an image of one or more feature portions of the device arranged in the target arrangement.

11. The assistance system for arrangement work on devices of an elevator according to claim 1, comprising:
a speaker that notifies, with respect to at least any of the one or more devices, that the device has entered a first range set in advance with respect to a target arrangement corresponding to the device.

12. The assistance system for arrangement work on devices of an elevator according to claim 11, wherein
the speaker notifies by second audio, with respect to at least any of devices to which the first range is set among the one or more devices, that the device has entered a second range which is included in the first range and which is set in advance with respect to a target arrangement that corresponds to the device.

13. The assistance system for arrangement work on devices of an elevator according to claim 1, wherein
the camera system is provided so as to be prevented from moving from start to finish of the arrangement work.

14. The assistance system for arrangement work on devices of an elevator according to claim 1, wherein
when the one or more devices in the arrangement work include a traction machine, the camera system is arranged vertically above or arranged vertically below a sheave of the traction machine, and
the processing circuitry guides an arrangement to a target arrangement of the sheave with a sheave groove of the sheave as a reference.

15. The assistance system for arrangement work on devices of an elevator according to claim 1, wherein
when the one or more devices in the arrangement work include a landing device including a detector that detects landing of a car at each floor, the apparatus camera system is arranged vertically above or arranged vertically below the landing device in the car, and
the processing circuitry guides an arrangement to a target arrangement of the landing device with a groove of the detector which a landing plate provided on each floor passes when the car travels in the landing device as a reference.

16. The assistance system for arrangement work on devices of an elevator according to claim 1, wherein
the processing circuitry generates, by machine learning, a trained model for inferring a target arrangement from an image captured by the camera system using data for learning including an image captured by the camera system and a target arrangement of a device to be arranged in an area of the image among the one or more devices.

17. The assistance system for arrangement work on devices of an elevator according to claim 1, wherein
the processing circuitry infers, from an image captured by the camera system, a target arrangement of a device to be arranged in an area of the image among the one or more devices using a trained model for inferring a target arrangement from an image captured by the camera system, the trained model having been generated by machine learning using data for learning including an image captured by the camera system and a target arrangement of the device, and
the processing circuitry obtains a target arrangement corresponding to the device based on an inference by the processing circuitry.

18. The assistance system for arrangement work on devices of an elevator according to claim 17, wherein
the trained model used by the processing circuitry for inference is a trained model for inferring, from an image captured by the camera system, a target arrangement of a device to be arranged in an area of the image among the one or more devices and one of more feature portions of the device,
the processing circuitry infers a target arrangement and one or more feature portions of the device from an image captured by the camera system, and
the processing circuitry guides the device to the target arrangement inferred by the processing circuitry based on the target arrangement and the one or more feature portions inferred by the processing circuitry.
